(19) United States
(12) Patent Application Publication
(10) Pub. No.: US 2019/0168317 A1
(43) Pub. Date: Jun. 6, 2019

(54) PRODUCTION METHOD FOR OPTICAL LAMINATE

(71) Applicant: NITTO DENKO CORPORATION, Ibaraki-shi, Osaka (JP)

(72) Inventors: Toshihiro Kanno, Ibaraki-shi (JP); Kota Nakai, Ibaraki-shi (JP); Takeshi Murashige, Ibaraki-shi (JP)

(73) Assignee: NITTO DENKO CORPORATION, Ibaraki-shi, Osaka (JP)

(21) Appl. No.: 16/309,000

(22) PCT Filed: Mar. 23, 2018
(86) PCT No.: PCT/JP2018/011605

§ 371 Date: Dec. 11, 2018

(30) Foreign Application Priority Data
May 29, 2017 (JP) 2017-105199
Mar. 22, 2018 (JP) 2018-054031

(51) Int. Cl. B23C 3/13; B32B 17/10; B32B 38/00; C03C 19/00; B23C 5/06

(52) U.S. Cl. CPC B23C 3/13; B32B 17/10458; B32B 2307/42; C03C 19/00; B23C 5/06; B32B 38/0004

(57) ABSTRACT

There is provided a method by which a glass plate and an optical functional film can be integrally subjected to machining processing without the occurrence of any inconvenience. A production method for an optical laminate according to the present invention includes: laminating a glass plate and an optical functional film to form an optical laminate; superimposing a plurality of the optical laminates to form a workpiece; and relatively moving the workpiece and machining means, which includes a rotating shaft extending in a lamination direction of the workpiece and a machining blade formed as an outermost diameter of a main body configured to rotate about the rotating shaft, while rotating the machining means, to subject outer peripheral surfaces of the workpiece to machining processing. In the method, a feed per blade in the machining processing is from 5 μm/blade to 30 μm/blade.

### TECHNICAL FIELD

The present invention relates to a production method for an optical laminate.

### BACKGROUND ART

A protective material for protecting an image display apparatus is often arranged on the outermost surface side of the image display apparatus. A glass plate has been typically used as the protective material (e.g., Patent Literature 1). Along with the downsizing, thinning, and light-weighting of the image display apparatus, there has been a growing demand for a thin protective material having both a protective function and an optical function (optical laminate). Such optical laminate is, for example, an optical laminate including a glass plate serving as a protective material and a polarizing plate serving as an optical functional film.

By the way, the cutting-processed surface of an optical functional film cut into a predetermined size and a predetermined shape is sometimes subjected to machining processing for the purpose of removing burrs and the like (e.g., Patent Literature 2). Here, when an attempt is made to subject such optical laminate including a glass plate and an optical functional film as described above to machining processing, machining conditions suitable for the glass plate and machining conditions suitable for the optical functional film (resin film) largely differ from each other. Accordingly, the fact is that the glass plate and the optical functional film need to be laminated after the plate and the film have been separately subjected to machining processing. Therefore, a technology for subjecting the optical laminate including the glass plate and the optical functional film to machining processing without causing any inconvenience has been desired.

### CITATION LIST

### Patent Literature

[PTL 1] JP 2010-164938 A

[PTL 2] JP 61-136746 A

### SUMMARY OF INVENTION

### Technical Problem

The present invention has been made to solve the conventional problem, and a primary object of the present invention is to provide a method by which a glass plate and an optical functional film can be integrally subjected to machining processing without the occurrence of any inconvenience.

### Solution to Problem

A production method for an optical laminate according to the present invention includes: laminating a glass plate and an optical functional film to form an optical laminate; superimposing a plurality of the optical laminates to form a workpiece; and relatively moving the workpiece and machining means, which includes a rotating shaft extending in a lamination direction of the workpiece and a machining blade formed as an outermost diameter of a main body configured to rotate about the rotating shaft, while rotating the machining means, to subject outer peripheral surfaces of the workpiece to machining processing. In the method, a feed per blade in the machining processing is from 5 μm/blade to 30 μm/blade. In one embodiment of the present invention, the feed per blade is from 5 μm/blade to 15 μm/blade.

In one embodiment of the present invention, a blade number of the machining means is from 2 to 10.

In one embodiment of the present invention, a feed speed of the machining means in the machining processing is 100 mm/min or more.

In one embodiment of the present invention, a blade angle of the machining means is from 0° to 20.

In one embodiment of the present invention, the optical functional film includes a polarizing plate.

### Advantageous Effects of Invention

According to the production method for an optical laminate of the present invention, end mill processing is adopted in the machining processing of an optical laminate including a glass plate and an optical functional film, and a feed per blade in the end mill processing is optimized, and hence the glass plate and the optical functional film can be integrally subjected to the machining processing without the occurrence of any inconvenience. In more detail, a crack in the glass plate can be prevented, and the yellow band (discoloration due to heat) of the optical functional film can be prevented. The following effects have been incidentally achieved by the achievement of such integral machining processing of the glass plate and the optical functional film: (1) the feed per blade can be made much larger than that in the case where the glass plate alone is subjected to machining processing, and hence productivity can be markedly improved; (2) the number of steps can be reduced as compared to that in the case where the glass plate and the optical functional film are separately subjected to machining processing, and hence the productivity can be improved and cost can be reduced; and (3) misregistration between the glass plate and the optical functional film at the time of their lamination can be prevented, and hence an optical laminate excellent in lamination accuracy can be obtained. Thus, according to the production method for an optical laminate of the present invention, problems that have heretofore been known but have been unsolvable can be solved.

### BRIEF DESCRIPTION OF DRAWINGS

FIG. 1 is a schematic sectional view of an optical laminate that may be used in an embodiment of the present invention.

FIG. 2 is a schematic perspective view for illustrating machining processing in a production method of the present invention.

FIG. 3 is a schematic view for illustrating an example of the structure of machining means to be used in the machining processing in the production method of the present invention.

### DESCRIPTION OF EMBODIMENTS

Specific embodiments of the present invention are described below with reference to the drawings. However, the present invention is not limited to the embodiments. The drawings are schematic for ease of viewing, and a ratio among, for example, a length, a width, and a thickness, an angle, and the like in each drawing are different from actual ones.

A production method for an optical laminate of the present invention includes: laminating a glass plate and an optical functional film to form an optical laminate; superimposing a plurality of the optical laminates to form a workpiece; and relatively moving the workpiece and machining means, which includes a rotating shaft extending in the lamination direction of the workpiece and a machining blade formed as the outermost diameter of a main body configured to rotate about the rotating shaft, while rotating the machining means, to subject the outer peripheral surfaces of the workpiece to machining processing. In an embodiment of the present invention, a feed per blade in the machining processing is from 5 μm/blade to 30 μm/blade, preferably from 5 μm/blade to 15 μm/blade, more preferably from 7 μm/blade to 10 μm/blade. The optical functional film is, for example, any appropriate optical functional film on which the glass plate serving as a protective material may be laminated. Specific examples of the optical functional film include a polarizing plate, a retardation plate, a conductive film for a touch panel, a surface-treated film, and a laminate obtained by appropriately laminating such plates or films in accordance with purposes (e.g., a circularly polarizing plate for antireflection or a polarizing plate with a conductive layer for a touch panel). Each step in a production method for an optical laminate including the glass plate and a polarizing plate serving as an example of the production method is described below.

A. Formation of Optical Laminate

First, the glass plate and the polarizing plate are laminated. The lamination may be performed by any appropriate method. In one embodiment, the glass plate and the polarizing plate may be laminated by a so-called roll-to-roll process. The term “roll-to-roll process” as used herein refers to the following: an elongated glass plate and an elongated polarizing plate are bonded to each other so that their longitudinal directions may be aligned with each other while the plates are conveyed. In another embodiment, the glass plate and the polarizing plate may be laminated after the plates have each been cut into a predetermined shape. The lamination may be typically performed via any appropriate adhesion layer (adhesive layer or pressure-sensitive adhesive layer).

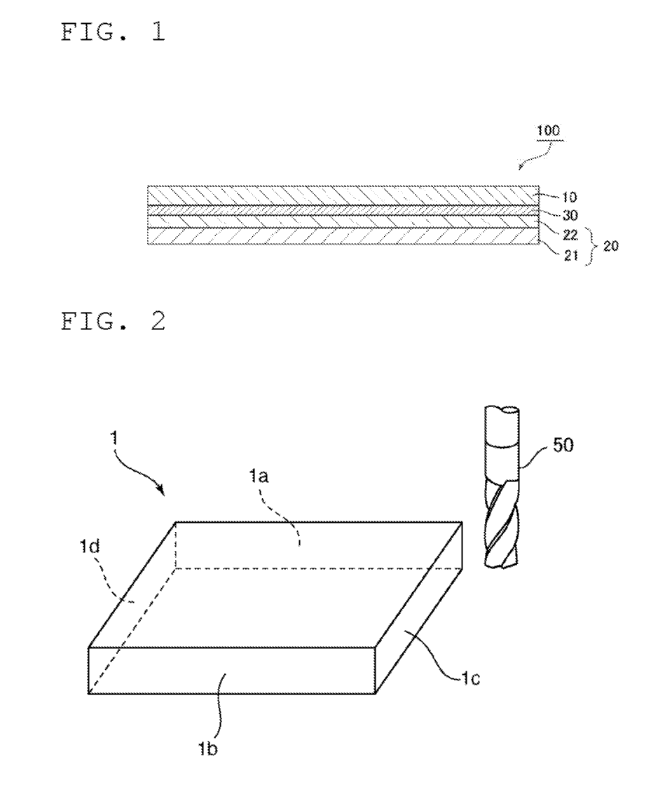

FIG. 1 is a schematic sectional view of an optical laminate obtained as described above. An optical laminate 100 includes a glass plate 10 and a polarizing plate 20. The polarizing plate 20 typically includes a polarizer 21 and a protective film 22 arranged on one surface of the polarizer 21 (in the illustrated example, the surface on the glass plate 10 side). The polarizing plate may further include a protective film (not shown) arranged on the surface of the polarizer opposite to the glass plate. The glass plate 10 and the polarizing plate 20 are typically laminated via an adhesion layer (e.g., an adhesive layer or a pressure-sensitive adhesive layer) 30. The optical laminate 100 typically includes a pressure-sensitive adhesive layer (not shown) as an outermost layer opposite to the glass plate. Practically, a separator is temporarily bonded to the pressure-sensitive adhesive layer to protect the pressure-sensitive adhesive layer until the layer is used, and to enable the formation of the optical laminate into a roll.

The thickness of the optical laminate is preferably from 1 μm to 300 μm, more preferably from 10 μm to 200 μm, still more preferably from 20 μm to 150 μm.

Any appropriate glass plate may be adopted as the glass plate. Examples of the glass forming the glass plate include soda-lime glass, borate glass, aluminosilicate glass, and quartz glass according to the classification based on a composition. In addition, according to the classification based on an alkali component, alkali-free glass and low alkali glass are exemplified. The content of an alkali metal component (e.g., Na₂O, K₂O, Li₂O) of the glass is preferably 15 wt % or less, more preferably 10 wt % or less.

The thickness of the glass plate is preferably 200 μm or less, more preferably 150 μm or less, still more preferably 120 μm or less, particularly preferably 100 μm or less. Meanwhile, the thickness of the glass plate is preferably 5 μm or more, more preferably 20 μm or more. When the thickness falls within such range, the lamination by the roll-to-roll process becomes possible.

The light transmittance of the glass plate at a wavelength of 550 nm is preferably 85% or more. The refractive index of the glass plate at a wavelength of 550 nm is preferably from 1.4 to 1.65. The density of the glass plate is preferably from 2.3 g/cm³ to 3.0 g/cm³, more preferably from 2.3 g/cm³ to 2.7 g/cm³.

As the glass plate, a commercially available glass plate may be used as it is, or the commercially available glass plate may be used after being polished so as to have a desired thickness. Examples of the commercially available glass plate include “7059”, “1737”, or “EAGLE 2000” manufactured by Corning Incorporated, “AN100” manufactured by Asahi Glass Co., Ltd., “NA-35” manufactured by NH Technoglass Corporation, “OA-10” manufactured by Nippon Electric Glass Co., Ltd., and “D263” or “AF45” manufactured by SCHOTT AG.

Detailed description of the polarizer 21 and the protective film 22 is omitted because constructions well-known in the art may be adopted.

B. Formation of Workpiece

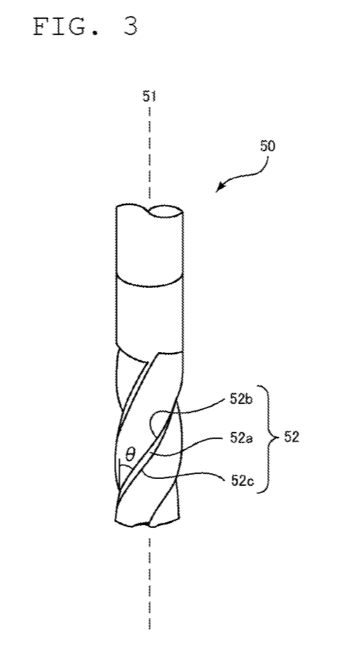

FIG. 2 is a schematic perspective view for illustrating the machining processing in the production method of the present invention, and a workpiece 1 is shown in the figure. As shown in FIG. 2, the workpiece 1 is formed by superimposing a plurality of optical laminates cut into predetermined shapes. The optical laminates that are obtained by the roll-to-roll process (and are consequently of elongated shapes or roll shapes) are cut into the predetermined shapes and then superimposed to form the workpiece. The optical laminates each formed by laminating the glass plate and the polarizing plate each cut into a predetermined shape may be superimposed as they are to form the workpiece, or may be superimposed to form the workpiece after the laminates have each been further cut into a shape to be finally desired.

The workpiece 1 has outer peripheral surfaces (machining surfaces) 1a and 1b opposite to each other, and outer peripheral surfaces (machining surfaces) 1c and 1d perpendicular thereto. The workpiece 1 is preferably vertically clamped with clamping means (not shown). The total thickness of the workpiece is preferably 1 mm or more, more preferably 3 mm or more, still more preferably 5 mm or more. An upper limit for the total thickness of the workpiece is, for example, 150 mm. With such thickness, damage to the workpiece due to a pressing force by the clamping means or due to impact at the time of the machining processing can be prevented. The optical laminates are superimposed so that the workpiece may have such total thickness. The number of the optical laminates forming the workpiece is 10 or more in one embodiment, and is from 30 to 50 in one embodiment. The clamping means (e.g., a jig) may be formed of a soft material, or may be formed of a hard material. When the means is formed of a soft material, its hardness (JIS A) is preferably from 60° to 80°. When the hardness is excessively high, an indentation by the clamping means remains in some cases. When the hardness is excessively low, the positional shift of the workpiece is caused by the deformation of the jig, and hence machining accuracy becomes insufficient in some cases.

C. Machining Processing

Next, predetermined positions of the outer peripheral surfaces of the workpiece 1 are machined with machining means 50. As illustrated in FIG. 2, the machining processing is so-called end mill processing. A straight end mill may be typically used as the machining means (end mill) 50.

Specifically, as illustrated in FIG. 3, the machining means (end mill) 50 includes a rotating shaft 51 extending in the lamination direction (vertical direction) of the workpiece 1 and machining blades 52 each formed as the outermost diameter of a main body configured to rotate about the rotating shaft 51. In the illustrated example, the machining blades 52 are each formed as an outermost diameter twisted along the rotating shaft 51. The machining blades 52 each include a blade edge 52a, a rake face 52b, and an escape face 52c. The number of the machining blades 52 may be appropriately set in accordance with purposes. The blade number is preferably from 2 to 10, more preferably from 5 to 7. In the illustrated example, a construction in which the blade number is 3 is illustrated for ease of viewing. In the embodiment of the present invention, the blade number is set to a large value as described above, and the feed speed (described later) of the machining means is increased, and hence a desired feed per blade is achieved, and as a result, the glass plate and the optical functional film can be integrally subjected to machining processing without the occurrence of any inconvenience. The blade angle (helix angle θ of each machining blade in the illustrated example) of the machining means is preferably from 0° to 75°, more preferably from 0° to 60°, still more preferably from 0° to 20°. The rake angle (not shown) of the machining means is preferably from −45 to +10, more preferably from 0 to +5°. When the rake angle falls within such range, the chipping of the blade edge in the machining processing can be prevented. The escape face of each machining blade is preferably subjected to a surface-roughening treatment. Any appropriate treatment may be adopted as the surface-roughening treatment. A typical example thereof is a blast treatment. In addition, blade faces (the rake face and the escape face) may each be subjected to a coating treatment. A typical example of the coating treatment is a DLC treatment. When the DLC treatment is performed, the surface hardness of each of the blade faces increases, and hence the wear and/or chipping of the blade edge can be suppressed.

Conditions for the machining processing are specifically described. In the embodiment of the present invention, as described above, the feed per blade is from 5 μm/blade to 30 μm/blade, preferably from 5 μm/blade to 15 μm/blade, more preferably from 7 μm/blade to 10 μm/blade. According to the embodiment of the present invention, when the feed per blade is optimized to such range, a crack in the glass plate can be prevented, and the yellow band (discoloration due to heat) of the polarizing plate can be prevented. The feed per blade is represented by the following equation:

feed per blade f(μm/blade)=F/(N×n)

where F represents the feed speed (mm/min) of the machining means, N represents the number of revolutions (rpm) thereof, and n represents the blade number thereof.

The diameter of the machining means (end mill) 50 is preferably from 3 mm to 20 mm. The number of revolutions of the machining means is preferably from 1,000 rpm to 60,000 rpm, more preferably from 10,000 rpm to 40,000 rpm. The feed speed of the machining means is preferably 100 mm/min or more, more preferably 200 mm/min or more. Meanwhile, the feed speed is preferably 10,000 mm/min or less, more preferably 7,000 ma/min or less, still more preferably 4,000 mm/min or less. The number of times of machining of a site to be machined may be one, two, or three or more.

In one embodiment, the machining processing may be performed as wet processing. Specifically, the machining processing may be performed while a machining liquid is supplied to the site to be machined. According to such construction, the machining liquid can function as a lubricant, and hence the wear of the blade edge is suppressed and the lifetime of the machining means can be lengthened.

Thus, an optical laminate subjected to the machining processing can be obtained.

### EXAMPLES

Now, the present invention is described in detail by way of Examples. However, the present invention is not limited to these Examples. Evaluation items in Examples are as follows.

(1) Crack

The state of an optical laminate after machining processing of each of Examples and Comparative Examples was observed with an optical microscope, and was evaluated by the following criteria.

⊚ (Excellent): The length of a crack is less than 100 μm.

∘ (Good): The length of a crack is from 100 μm to 200 μm.

x (Bad): The length of a crack is more than 200 μm.

(2) Yellow Band

The state of the optical laminate after machining processing of each of Examples and Comparative Examples was observed with an optical microscope, and was evaluated by the following criteria.

∘ (Good): The length of a yellow band is 400 μm or less.

x (Bad): The length of a yellow band is more than 400 μm.

### Reference Example 1: Production of Optical Laminate and Workpiece

A film (thickness: 28 μm) obtained by incorporating iodine into an elongated polyvinyl alcohol (PVA)-based resin film and uniaxially stretching the resultant in its lengthwise direction (MD direction) was used as a polarizer. A pressure-sensitive adhesive layer (thickness: 5 μm) was formed on one side of the polarizer, and an elongated triacetylcellulose (TAC) film (thickness: 25 μm) was bonded to the polarizer via the pressure-sensitive adhesive layer so that their lengthwise directions were aligned with each other. Thus, an elongated polarizing plate having the construction “TAC film (protective film)/polarizer” was obtained.

A UV-curable adhesive was applied to the TAC film side of the polarizing plate obtained in the foregoing so that its thickness after curing became 2 μm. An elongated glass plate (manufactured by Schott AG, product name: “D 263,” thickness: 100 μm) was bonded to the applied surface so that the lengthwise directions of the plates were aligned with each other. Then, the adhesive was irradiated with UV light to be cured. Thus, an elongated optical laminate having the construction “glass plate/TAC film (protective film)/polarizer” was obtained. A pressure-sensitive adhesive layer was formed on the polarizer surface of the resultant optical laminate, and a separator was bonded to the pressure-sensitive adhesive layer. The optical laminate was punched into a 5.7-inch size (measuring about 140 mm long by about 65 mm wide), and 40 punched optical laminates were superimposed to provide a workpiece.

### Example 1

The outer peripheral surfaces of the workpiece obtained in Reference Example 1 were subjected to machining processing (cutting depth: 0.15 mm, single machining) by end mill processing under a state in which the workpiece was sandwiched between clamps (jigs). Here, the end mill had a blade number of 6, a blade angle of 10°, a feed speed of 1, 440 mm/min, and a number of revolutions of 30,000 rpm. Therefore, a feed per blade was 8 μm/blade. The optical laminate subjected to the machining processing was evaluated as described in the (1) and (2). The results are shown in Table 1.

### Example 2

An optical laminate subjected to machining processing was obtained in the same manner as in Example 1 except that the feed speed was changed to 1,800 mm/min (and therefore, the feed per blade was changed to 10 μm/blade). The optical laminate subjected to the machining processing was evaluated in the same manner as in Example 1. The results are shown in Table 1.

### Example 3

An optical laminate subjected to machining processing was obtained in the same manner as in Example 1 except that the feed speed was changed to 900 mm/min (and therefore, the feed per blade was changed to 5 μm/blade). The optical laminate subjected to the machining processing was evaluated in the same manner as in Example 1. The results are shown in Table 1.

### Example 4

An optical laminate subjected to machining processing was obtained in the same manner as in Example 1 except that the feed speed was changed to 3, 600 mm/min (and therefore, the feed per blade was changed to 20 μm/blade). The optical laminate subjected to the machining processing was evaluated in the same manner as in Example 1. The results are shown in Table 1.

### Comparative Example 1

An optical laminate subjected to machining processing was obtained in the same manner as in Example 1 except that the feed speed was changed to 720 mm/min (and therefore, the feed per blade was changed to 4 μm/blade). The optical laminate subjected to the machining processing was evaluated in the same manner as in Example 1. The results are shown in Table 1.

### Comparative Example 2

An optical laminate subjected to machining processing was obtained in the same manner as in Example 1 except that the feed speed was changed to 7,200 mm/min (and therefore, the feed per blade was changed to 40 μm/blade). The optical laminate subjected to the machining processing was evaluated in the same manner as in Example 1. The results are shown in Table 1.

### Example 5

An optical laminate subjected to machining processing was obtained in the same manner as in Example 1 except that the number of revolutions was changed to 24,000 rpm (and therefore, the feed per blade was changed to 10 μm/blade). The optical laminate subjected to the machining processing was evaluated in the same manner as in Example 1. The results are shown in Table 1.

### Example 6

An optical laminate subjected to machining processing was obtained in the same manner as in Example 1 except that the number of revolutions was changed to 48,000 rpm (and therefore, the feed per blade was changed to 5 μm/blade). The optical laminate subjected to the machining processing was evaluated in the same manner as in Example 1. The results are shown in Table 1.

### Example 7

An optical laminate subjected to machining processing was obtained in the same manner as in Example 1 except that the number of revolutions was changed to 12,000 rpm (and therefore, the feed per blade was changed to 20 μm/blade). The optical laminate subjected to the machining processing was evaluated in the same manner as in Example 1. The results are shown in Table 1.

### Comparative Example 3

An optical laminate subjected to machining processing was obtained in the same manner as in Example 1 except that the number of revolutions was changed to 60,000 rpm (and therefore, the feed per blade was changed to 4 μm/blade). The optical laminate subjected to the machining processing was evaluated in the same manner as in Example 1. The results are shown in Table 1.

### Comparative Example 4

An optical laminate subjected to machining processing was obtained in the same manner as in Example 1 except that the number of revolutions was changed to 6,000 rpm (and therefore, the feed per blade was changed to 40 μm/blade). The optical laminate subjected to the machining processing was evaluated in the same manner as in Example 1. The results are shown in Table 1.

### Example 8

An optical laminate subjected to machining processing was obtained in the same manner as in Example 1 except that the blade number was changed to 8 (and therefore, the feed per blade was changed to 6 μm/blade). The optical laminate subjected to the machining processing was evaluated in the same manner as in Example 1. The results are shown in Table 1.

### Example 9

An optical laminate subjected to machining processing was obtained in the same manner as in Example 1 except that the blade number was changed to 10, the blade angle was changed to 50, and the number of revolutions was changed to 14,400 rpm (and therefore, the feed per blade was changed to 10 μm/blade). The optical laminate subjected to the machining processing was evaluated in the same manner as in Example 1. The results are shown in Table 1.

### Example 10

An optical laminate subjected to machining processing was obtained in the same manner as in Example 1 except that the blade number was changed to 10, the blade angle was changed to 5°, the number of revolutions was changed to 14, 400 rpm, and the feed speed was changed to 2,880 mm/min (and therefore, the feed per blade was changed to 20 μm/blade). The optical laminate subjected to the machining processing was evaluated in the same manner as in Example 1. The results are shown in Table 1.

### Comparative Example 5

An optical laminate subjected to machining processing was obtained in the same manner as in Example 1 except that the blade number was changed to 10, the blade angle was changed to 5°, the number of revolutions was changed to 60,000 rpm, and the feed speed was changed to 600 mm/min (and therefore, the feed per blade was changed to 1 μm/blade). The optical laminate subjected to the machining processing was evaluated in the same manner as in Example 1. The results are shown in Table 1.

### Comparative Example 6

An optical laminate subjected to machining processing was obtained in the same manner as in Example 1 except that the number of revolutions was changed to 15,000 rpm and the feed speed was changed to 7,200 μm/min (and therefore, the feed per blade was changed to 80 μm/blade). The optical laminate subjected to the machining processing was evaluated in the same manner as in Example 1. The results are shown in Table 1.

### Example 11

The outer peripheral surfaces of the workpiece obtained in Reference Example 1 were subjected to machining processing (cutting depth: 1 mm, single machining) by end mill processing under a state in which the workpiece was sandwiched between clamps (jigs). Here, the end mill had a blade number of 2, a blade angle of 45°, a feed speed of 400 mm/min, and a number of revolutions of 20,000 rpm. Therefore, a feed per blade was 10 μm/blade. The optical laminate subjected to the machining processing was evaluated as described in the (1) and (2). The results are shown in Table 1.

### Example 12

An optical laminate subjected to machining processing was obtained in the same manner as in Example 11 except that the feed speed was changed to 200 mm/min and the number of revolutions was changed to 10,000 rpm (and therefore, the feed per blade was kept at 10 μm/blade). The optical laminate subjected to the machining processing was evaluated in the same manner as in Example 1. The results are shown in Table 1.

### Example 13

An optical laminate subjected to machining processing was obtained in the same manner as in Example 11 except that the feed speed was changed to 100 mm/min and the number of revolutions was changed to 10,000 rpm (and therefore, the feed per blade was changed to 5 μm/blade). The optical laminate subjected to the machining processing was evaluated in the same manner as in Example 1. The results are shown in Table 1.

### Comparative Example 7

An optical laminate subjected to machining processing was obtained in the same manner as in Example 11 except that the feed speed was changed to 20 mm/min and the number of revolutions was changed to 10,000 rpm (and therefore, the feed per blade was changed to 1 μm/blade). The optical laminate subjected to the machining processing was evaluated in the same manner as in Example 1. The results are shown in Table 1.

### Comparative Example 8

An optical laminate subjected to machining processing was obtained in the same manner as in Example 11 except that the feed speed was changed to 1,000 mm/min and the number of revolutions was changed to 10,000 rpm (and therefore, the feed per blade was changed to 50 μm/blade). The optical laminate subjected to the machining processing was evaluated in the same manner as in Example 1. The results are shown in Table 1.

### Comparative Example 9

An optical laminate subjected to machining processing was obtained in the same manner as in Example 11 except that the feed speed was changed to 1,400 mm/min and the number of revolutions was changed to 10,000 rpm (and therefore, the feed per blade was changed to 70 μm/blade). The optical laminate subjected to the machining processing was evaluated in the same manner as in Example 1. The results are shown in Table 1.

TABLE 1

| | Feed | Number of | Blade | Feed per | Blade | | |
|---|---|---|---|---|---|---|---|
| | speed | revolutions | number | blade | angle | | Yellow |
| | (mm/min) | (rpm) | (blades) | (μm/blade) | (°) | Crack | band |
| Example 1 | 1,440 | 30,000 | 6 | 8 | 10 | ⊚ | ◯ |
| Example 2 | 1,800 | 30,000 | 6 | 10 | 10 | ⊚ | ◯ |
| Example 3 | 900 | 30,000 | 6 | 5 | 10 | ⊚ | ◯ |
| Example 4 | 3,600 | 30,000 | 6 | 20 | 10 | ◯ | ◯ |
| Comparative | 720 | 30,000 | 6 | 4 | 10 | ⊚ | X |
| Example 1 | | | | | | | |
| Comparative | 7,200 | 30,000 | 6 | 40 | 10 | X | ◯ |
| Example 2 | | | | | | | |
| Example 5 | 1,440 | 24,000 | 6 | 10 | 10 | ⊚ | ◯ |
| Example 6 | 1,440 | 48,000 | 6 | 5 | 10 | ⊚ | ◯ |
| Example 7 | 1,440 | 12,000 | 6 | 20 | 10 | ◯ | ◯ |
| Comparative | 1,440 | 60,000 | 6 | 4 | 10 | ⊚ | X |
| Example 3 | | | | | | | |
| Comparative | 1,440 | 6,000 | 6 | 40 | 10 | X | ◯ |
| Example 4 | | | | | | | |
| Example 8 | 1,440 | 30,000 | 8 | 6 | 10 | ⊚ | ◯ |
| Example 9 | 1,440 | 14,400 | 10 | 10 | 5 | ⊚ | ◯ |
| Example 10 | 2,880 | 14,400 | 10 | 20 | 5 | ◯ | ◯ |
| Comparative | 600 | 60,000 | 10 | 1 | 5 | ⊚ | X |
| Example 5 | | | | | | | |
| Comparative | 7,200 | 15,000 | 6 | 80 | 10 | X | ◯ |
| Example 6 | | | | | | | |
| Example 11 | 400 | 20,000 | 2 | 10 | 45 | ◯ | ◯ |
| Example 12 | 200 | 10,000 | 2 | 10 | 45 | ◯ | ◯ |
| Example 13 | 100 | 10,000 | 2 | 5 | 45 | ◯ | ◯ |
| Comparative | 20 | 10,000 | 2 | 1 | 45 | ◯ | X |
| Example 7 | | | | | | | |
| Comparative | 1,000 | 10,000 | 2 | 50 | 45 | X | ◯ |
| Example 8 | | | | | | | |
| Comparative | 1,400 | 10,000 | 2 | 70 | 45 | X | ◯ |
| Example 9 | | | | | | | |

As is apparent from Table 1, machining processing in which both of a crack in a glass plate and the yellow band of a polarizing plate are suppressed can be achieved by controlling a feed per blade in end mill processing within a predetermined range.

### INDUSTRIAL APPLICABILITY

The production method of the present invention can be suitably used in the production of an optical laminate that includes a glass plate and an optical functional film, and requires machining processing. An optical laminate obtained by the production method of the present invention can be suitably used in various image display apparatus.

### REFERENCE SIGNS LIST

1 workpiece
10 glass plate
20 polarizing plate
50 machining means
100 optical laminate

1. A production method for an optical laminate, comprising:
laminating a glass plate and an optical functional film to form an optical laminate;
superimposing a plurality of the optical laminates to form a workpiece; and
relatively moving the workpiece and machining means, which includes a rotating shaft extending in a lamination direction of the workpiece and a machining blade formed as an outermost diameter of a main body configured to rotate about the rotating shaft, while rotating the machining means, to subject outer peripheral surfaces of the workpiece to machining processing,
wherein a feed per blade in the machining processing is from 5 μm/blade to 30 μm/blade.

2. The production method according to claim 1, wherein the feed per blade is from 5 μm/blade to 15 μm/blade.

3. The production method according to claim 1, wherein a blade number of the machining means is from 2 to 10.

4. The production method according to claim 1, wherein a feed speed of the machining means in the machining processing is 100 nm/min or more.

5. The production method according to claim 1, wherein a blade angle of the machining means is from 0° to 20°.

6. The production method according to claim 1, wherein the optical functional film comprises a polarizing plate.

7. The production method according to claim 1, wherein a diameter of the machining means is 3 mm to 20 mm.

8. The production method according to claim 1, wherein the number of revolutions of the machining means is from 1,000 rpm to 60,000 rpm.

9. A production method for an optical laminate, comprising:
laminating a glass plate and an optical functional film to form an optical laminate;
superimposing a plurality of the optical laminates to form a workpiece; and
relatively moving the workpiece and machining means, which includes a rotating shaft extending in a lamination direction of the workpiece and a machining blade formed as an outermost diameter of a main body configured to rotate about the rotating shaft, while rotating the machining means, to subject outer peripheral surfaces of the workpiece to machining processing,
wherein the optical functional film comprises a polarizing plate,
wherein a diameter of the machining means is 3 mm to 20 mm, a blade number of the machining means is from 2 to 10, the number of revolutions of the machining means is from 1,000 rpm to 60,000 rpm, and a feed speed of the machining means in the machining processing is 100 mm/min or more, and
wherein a feed per blade in the machining processing is from 5 μm/blade to 30 μm/blade.

10. The production method according to claim 9, wherein a blade angle of the machining means is from 0° to 20°.
